(19) United States
(12) Patent Application Publication
(10) Pub. No.: US 2016/0227605 A1
(43) Pub. Date: Aug. 4, 2016

(54) Network Control Hub Box

(71) Applicant: Chen-Hsuan Wu, New Taipei City (TW)

(72) Inventor: Chen-Hsuan Wu, New Taipei City (TW)

(21) Appl. No.: 14/613,372

(22) Filed: Feb. 4, 2015

(51) Int. Cl. H04W 88/10; H04L 29/06

(52) U.S. Cl. CPC H04W 88/10; H04L 69/08

(57) ABSTRACT

A network control hub box includes openings, at least one main control board, sub control boards, USB slots and USB wireless transceivers. The openings are situated at the network control hub box to form a multiple of accommodating spaces; the main control board is disposed in one of the accommodating spaces; the sub control boards are disposed in the remaining accommodating spaces respectively and electrically connected to the main control board; the USB slots are formed at the periphery of the main control board and the sub control board and configured to be corresponsive to the openings respectively; and the USB wireless transceivers are installed to the USB slots and have wireless transceiving circuits of different specifications respectively. The network control hub box is capable of controlling a multiple of endpoint devices of different wireless communication protocols or the same communication protocol, but having different specifications.

### BACKGROUND OF THE INVENTION

1. Field of the Invention

The present invention relates to a network control device, and more particularly to a network control hub box provided for a mobile device to directly or indirectly control a plurality of endpoint devices of different wireless communication protocols or the same communication protocol, but having different specifications.

2. Description of the Related Art

To satisfy the network bandwidth requirements and applications, wireless communication technologies of various specifications are developed and applied in our daily-life products such as: WCDMA, LTE used in mobile communication systems. With a connection between a mobile phone and a base station, users can log on networks, and the convenience of using mobile phones to users is improved significantly. Communication protocols such as Wifi, Bluetooth, Zigbee, Zwave, RFID, and EnOcean provide a relatively shorter transmission distance and thus are suitable for the local area network connections, and the Wifi systems can build a specific local area network and provide encryption for the local area network, and only authorized users can access the local area network for networking. At present, Bluetooth has a wide application range. For example, the data transmission of wireless earphones, wireless keyboards and mice or devices to devices can be achieved via Bluetooth transmission, and Bluetooth 4.0 with a better power saving mechanism will be well developed in the future. In addition, Zigbee and Zwave, and EnOcean with low power consumption and low transmission rate are usually used for wireless sensing and control such as household power control and medical surveillance, and RFID with a relatively shorter transmission distance is applied in areas such as electronic toll collection systems, identity recognition, logistics management, etc.

However the aforementioned wireless communication protocols of different specifications have different packet format and operating frequencies, so that the communication devices of different protocols cannot transmit or received signals from each other directly, so that it is necessary to use different conversion devices for the communication between each other, and such communication devices may convert the signals of a particular communication protocol only, but are unable to receive or transmit a plurality of signals of different communication protocols. If it is necessary to transmits signals to a plurality of devices of several different communication protocols, then the users have to change the signals through different responsive conversion devices respectively. Such arrangement has the disadvantages of taking much time to convert the signals, increasing the equipment cost, and reducing the communication rate.

In view of the disadvantages and drawbacks of the prior art, the present invention provides a network control hub box, and users can connect the network control hub box by an application program of a mobile device and control the endpoint equipments of different communication protocols, so that the users can control the endpoint devices of different communication protocols through use the mobile device to simplify the operation.

### SUMMARY OF THE INVENTION

Therefore, it is a primary objective of the present invention to provide a network control hub box provided for a user to control a plurality of devices of different communication protocols by a mobile device at a remote position and achieve the effects of quickly controlling endpoint devices of different communication protocols, saving the cost of intermediary conversion equipments and improving the communication rate.

To achieve the aforementioned objective, the present invention provides a network control hub box provided for a mobile device to directly or indirectly control a plurality of endpoint devices of different wireless communication protocols or the same communication protocol but having different specifications. The network control hub box comprises a plurality of openings, at least one main control board, a plurality of sub control boards, a plurality of USB slots and a plurality of USB wireless transceivers, wherein the openings are disposed on the network control hub box to form a plurality of accommodating spaces; the main control board is installed in one of the accommodating spaces; the sub control boards are installed in the remaining accommodating spaces respectively and electrically coupled to the main control board; and the USB slots are formed at the peripheries of the main control board and the sub control board and configured to be corresponsive to the openings respectively; the USB wireless transceivers are installed to he USB slots respectively, and the USB wireless transceivers are electrically coupled to the endpoint devices and have wireless transceiving circuits of different protocols respectively, and the wireless transceiving circuit is one selected from the group consisting of a Zigbee wireless transceiving circuit, a Zwave wireless transceiving circuit, a Wifi wireless transceiving circuit, a Bluetooth wireless transceiving circuit, a power line wireless transceiving circuit, an EnOcean wireless transceiving circuit and a RFID wireless transceiving circuit; and a control signal of the mobile device is transmitted or received through the USB wireless transceivers to control the endpoint devices with different communication protocols or the same communication protocol as well as different specifications.

Wherein, the network control hub box is electrically coupled to at least one wireless coordinator, and the mobile device is electrically coupled to the main control board through the wireless coordinator, or the network control hub box is electrically coupled to at least one router, and the mobile device is electrically coupled to the main control board through the router, and thus the mobile device has broader operation and control range.

In addition, the main control board includes a main control board coordinator installed therein, and the mobile device is electrically coupled to the main control board coordinator, so that the control signal received by the main control board can be transferred from the main control board coordinator to the USB wireless transceivers of different communication protocols.

In addition, the network control hub box further comprises a plurality of USB extenders, the USB extenders installed at the USB slots respectively, so that the network control hub box can be inserted with more USB wireless transceivers.

The network control hub box of the present invention is provided for a user to control different wireless endpoint devices by an application program of a mobile device, wherein the mobile device is directly or indirectly and electrically coupled to the network control hub box, and the USB wireless transceivers of a heterogeneous communication protocol is provided for controlling the endpoint devices, so as to simplify the control of the devices of different communication protocols.

### BRIEF DESCRIPTION OF THE DRAWINGS

FIG. 1 is an exploded view of a preferred embodiment of the present invention;

FIG. 2 is a perspective view of a preferred embodiment of the present invention;

FIG. 3 is a schematic view of an application in accordance with another implementation mode of a preferred embodiment of the present invention; and

FIG. 4 is a schematic view of an application in accordance with a further implementation mode of a preferred embodiment of the present invention.

### DETAILED DESCRIPTION OF THE PREFERRED EMBODIMENTS

The technical content of the present invention will become apparent with the detailed description of preferred embodiments and the illustration of related drawings as follows.

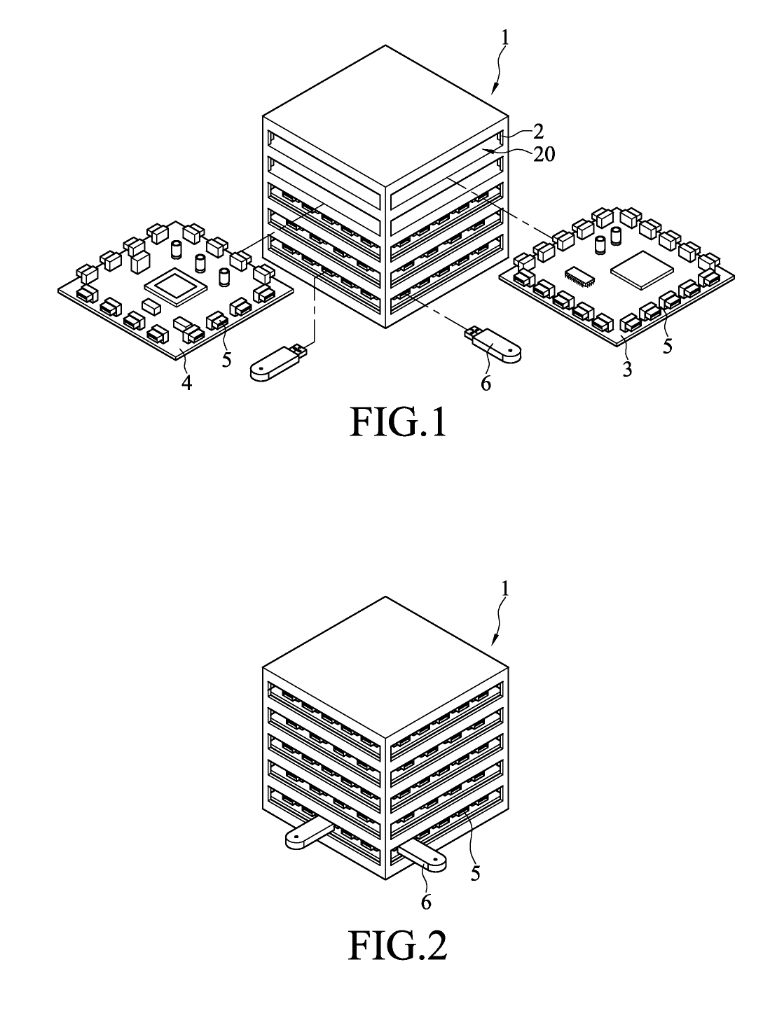

With reference to FIGS. 1 and 2 for an exploded view and a perspective view of a network control hub box in accordance with a preferred embodiment of the present invention respectively, the network control hub box 1 is provided for a mobile device 7 such as a Smartphone or tablet PC to directly or indirectly control a plurality of endpoint devices 9 of different wireless communication protocols or the same communication protocol but having different specifications. The network control hub box comprises a plurality of openings 2, at least one main control board 3, a plurality of sub control boards 4, a plurality of USB slots 5 and a plurality of USB wireless transceivers 6.

The openings 2 are disposed on the network control hub box 1 to form a plurality of accommodating spaces 20 and provided for installing the main control board 3 and the sub control boards 4. The main control board 3 is installed in one of the accommodating spaces 20, and the sub control boards 4 are installed in the remaining accommodating spaces 20 respectively and electrically coupled to the main control board 3, wherein the sub control board 4 is electrically coupled to the main control board 3 through a connecting method.

The USB slots 5 are formed at the peripheries of the main control board 3 and the sub control board 4 and configured to be corresponsive to the openings 2 respectively. The USB wireless transceivers 6 are installed on the USB slots 5 respectively and electrically coupled to the endpoint devices 9, and the USB wireless transceiver 6 have wireless transceiving circuits of different protocols, and the wireless transceiving circuit is one selected from the group consisting of a Zigbee wireless transceiving circuit, a Zwave wireless transceiving circuit, a Wifi wireless transceiving circuit, a Bluetooth wireless transceiving circuit, a power line wireless transceiving circuit, an EnOcean wireless transceiving circuit and a RFID wireless transceiving circuit. A control signal of the mobile device 7 is transmitted or received through the USB wireless transceivers 6 to control the endpoint devices 9 of different communication protocols or the same communication protocol but having different specifications. When use, a user sends out a control signal through the mobile device 7, and the network control hub box 1 receives the signal, and the main control board 3 together with the sub control boards 4 convert the communication format of the signal in order to achieve the effect of controlling each of the endpoint devices 9 from a remote position. The USB slots 5 are provided for connecting the USB wireless transceivers 6 of different communication protocols to each of the sub control boards 4 or the main control board 3 freely. After the signal of the mobile device 7 has been received by the main control board 3, the signal is transferred to each of the USB wireless transceivers 6 according to the communication system corresponsive to the desired controlling endpoint devices 9 through the respective wireless transceiving circuit, so as to achieve the effect of operating and controlling the endpoint devices 9 of various different communication formats.

In addition, the main control board 3 includes a main control board coordinator installed therein, and the mobile device 7 is electrically coupled to the main control board coordinator, and the main control board coordinator is provided for transferring the control signal of the mobile device 7 to the endpoint devices 9.

Wherein, the present invention may also use the network control hub box 1 as a network relay or a network access node through the main control board 3 or the sub control boards 4 in order to increase the transmission distance of the signal and extend the scope of application. In this embodiment, the main control board 3 is used as a main signal enhancement unit. In wireless or cable networks, the network control hub box 1 transmits and receives signals between the mobile device 7 and the endpoint devices 9 to the mobile device 7 control the endpoint devices 9 of different communication formats and also amplifies the control signal to extend the communication range and improve the practical effect of the application to obtain better performance.

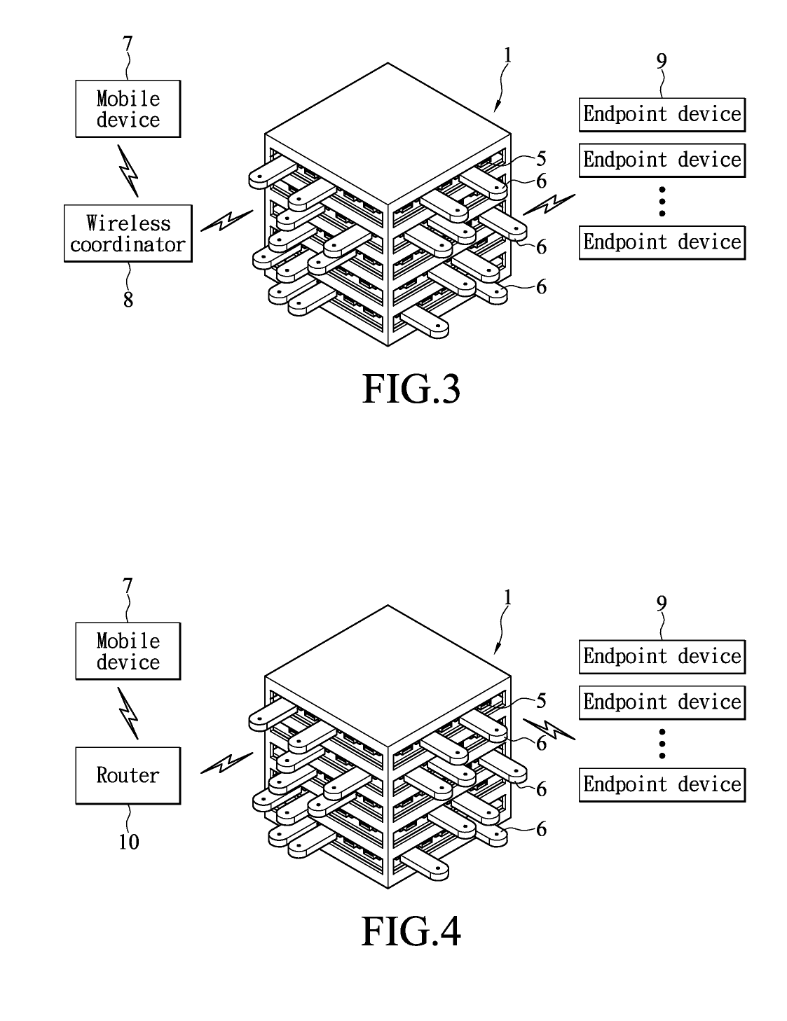

With reference to FIG. 3 for a schematic view of an application in accordance with another implementation mode of a preferred embodiment of the present invention, the network control hub box 1 is electrically coupled to at least one wireless coordinator 8, and the mobile device 7 is electrically coupled to the main control board 3 through the wireless coordinator 8. When the network control hub box 1 and the endpoint devices 9 are too far apart from each other, the wireless coordinator 8 can extend of the operation and control range of the mobile device 7 so as to further extend the transmission range of the whole network.

With reference to FIG. 4 for a schematic view of an application in accordance with a further implementation mode of a preferred embodiment of the present invention, the network control hub box 1 is electrically coupled to at least one router 10, and the mobile device 7 is electrically coupled to the main control board 3 through the router 10. When the network control hub box 1 and the endpoint devices 9 are too far from each other, the mobile device 7 can control the endpoint devices 9 from a farther distance through the router 10.

In addition, the network control hub box 1 further comprises a plurality of USB extenders installed to the USB slots 5 respectively, and the USB extenders have the effect of expanding the USB slots 5, so that more USB wireless transceivers 6 can be inserted.

The network control hub box 1 of the present invention is provided for users to control different wireless endpoint devices 9 through an application program of the mobile device 7, and the mobile device 7 is directly and electrically coupled to the network control hub box 1, or the wireless coordinator 8 or the router 10 is electrically coupled to the network control hub box 1, and the USB wireless transceivers 6 of a heterogeneous communication protocol is used to control the endpoint devices 9, so as to simplify the control of devices of different communication protocols. In addition, the network control hub box 1 may serves as a network relay or wireless access node of a cluster network independently to achieve the effects of expanding the wireless control signal and the cluster network, and extending the whole communication range for broader network architecture.

What is claimed is:

1. A network control hub box, provided for a mobile device to directly or indirectly control a plurality of endpoint devices of different wireless communication protocols or the same communication protocol but having different specifications, comprising:
a plurality of openings, disposed on the network control hub box to form a plurality of accommodating spaces;
at least one main control board, installed in one of the accommodating spaces;
a plurality of sub control boards, installed in the remaining accommodating spaces respectively, and electrically coupled to the main control board;
a plurality of USB slots, formed at the peripheries of the main control board and the sub control board, and configured to be corresponsive to the openings respectively; and
a plurality of USB wireless transceivers, installed to the USB slots respectively, and electrically coupled to the endpoint devices, and having wireless transceiving circuits of different protocols respectively, and the wireless transceiving circuit being one selected from the group consisting of a Zigbee wireless transceiving circuit, a Zwave wireless transceiving circuit, a Wifi wireless transceiving circuit, a Bluetooth wireless transceiving circuit, a power line wireless transceiving circuit, an EnOcean wireless transceiving circuit and a RFID wireless transceiving circuit, and a control signal of the mobile device being transmitted or received through the USB wireless transceivers to control the endpoint devices of different communication protocols or the same communication protocol, but having different specifications.

2. The network control hub box of claim 1, wherein the network control hub box is electrically coupled to at least one wireless coordinator, and the mobile device is electrically coupled to the main control board through the wireless coordinator.

3. The network control hub box of claim 1, wherein the main control board includes a main control board coordinator installed therein, and the mobile device is electrically coupled to the main control board coordinator.

4. The network control hub box of claim 1, wherein the network control hub box is electrically coupled to at least one router, and the mobile device is electrically coupled to the main control board through the router.

5. The network control hub box of any one of claim 2, further comprising a plurality of USB extenders installed at the USB slots respectively.

6. The network control hub box of any one of claim 3, further comprising a plurality of USB extenders installed at the USB slots respectively.

7. The network control hub box of any one of claim 4, further comprising a plurality of USB extenders installed at the USB slots respectively.
